(19) United States
(12) Patent Application Publication
(10) Pub. No.: US 2021/0304472 A1
(43) Pub. Date: Sep. 30, 2021

(54) METHOD OF CONTROLLING DISPLAY DEVICE, INFORMATION PROCESSING DEVICE, AND DISPLAY SYSTEM

(71) Applicant: SEIKO EPSON CORPORATION, Tokyo (JP)

(72) Inventors: Kyosuke ITAHANA, Matsumoto-shi (JP); Takahiro UEHARA, Chikuma-shi (JP)

(21) Appl. No.: 17/210,892

(22) Filed: Mar. 24, 2021

(30) Foreign Application Priority Data
Mar. 24, 2020 (JP) 2020-052206

(51) Int. Cl. G06T 11/60; G06F 3/0354; G06F 3/038

(52) U.S. Cl. CPC G06T 11/60; G06T 2200/24; G06F 3/038; G06F 3/03545

(57) ABSTRACT

A method of controlling a display device configured to display an image based on image information generated in accordance with a position of a pointing body includes the steps of monitoring a load value related to a load on a system which is configured to generate the image information in accordance with the position of the pointing body, performing a first mode configured to generate first image object information on which an editing process is performed, in accordance with the position of the pointing body, and then generate the image information using the first image object information when the load value is lower than a threshold value, and performing a second mode configured to generate second image object information in a format lower in the load on the system than a format of the first image object information in accordance with the position of the pointing body, and then generate the image information using the second image object information when the load value is equal to or higher than the threshold value.

The present application is based on, and claims priority from JP Application Serial Number 2020-052206, filed Mar. 24, 2020, the disclosure of which is hereby incorporated by reference herein in its entirety.

### BACKGROUND

### 1. Technical Field

The present disclosure relates to a method of controlling a display device, an information processing device, and a display system.

### 2. Related Art

There is known a display device such as a projector for displaying an image object which is drawn in accordance with a position of a pointing body such as a pen tool or a finger. For example, a device described in JP-A-2019-169037 (Document 1) generates image data in accordance with the position of the pointing body, and then displays an image represented by the image data. In Document 1, there is disclosed the fact that vector data on which an editing process can be performed is generated for each image object as the image data.

When the vector data is used as the image data, the device described in Document 1 generates the vector data in accordance with a drawing action with the pointing body irrespective of a level of a burden or a level of a processing performance of a system for generating the image data. Therefore, in the device described in Document 1, there is a problem that a time lag between the drawing action with the pointing body and the display of the image object based on the drawing action becomes distinctive, and as a result, the usability degrades.

### SUMMARY

In view of the problems described above, a method of controlling a display device according to an aspect of the present disclosure is a method of controlling a display device configured to display an image based on image information generated in accordance with a position of a pointing body, the method including the steps of monitoring a load value related to a load on a system which is configured to generate the image information in accordance with the position of the pointing body, performing a first mode configured to generate first image object information on which an editing process is performed, in accordance with the position of the pointing body, and then generate the image information using the first image object information when the load value is lower than a threshold value, and performing a second mode configured to generate second image object information in a format lower in the load on the system than a format of the first image object information in accordance with the position of the pointing body, and then generate the image information using the second image object information when the load value is equal to or higher than the threshold value.

An information processing device according to another aspect of the present disclosure is an information processing device configured to make a display device display an image based on image information generated in accordance with a position of a pointing body, the information processing device including a generation section configured to generate the image information in accordance with the position of the pointing body, a monitoring section configured to monitor a load value related to a load on a system used for the generation section, and an editing section configured to perform an editing process on the image information, wherein the generation section performs a first mode configured to generate first image object information in accordance with the position of the pointing body, and then generate the image information using the first image object information when the load value is lower than a threshold value, and a second mode configured to generate second image object information in accordance with the position of the pointing body, and then generate the image information using the second image object information when the load value is equal to or higher than the threshold value, the first image object information is information on which the editing process is performed by the editing section, and the second image object information is information in a format lower in load on the system than a format of the first image object information.

A display system according to another aspect of the present disclosure includes a generation section configured to generate image information in accordance with a position of a pointing body, a monitoring section configured to monitor a load value related to a load on a system used for the generation section, an editing section configured to perform an editing process on the image information, and a display section configured to display an image based on the image information, wherein the generation section performs a first mode configured to generate first image object information in accordance with the position of the pointing body, and then generate the image information using the first image object information when the load value is lower than a threshold value, and a second mode configured to generate second image object information in accordance with the position of the pointing body, and then generate the image information using the second image object information when the load value is equal to or higher than the threshold value, the first image object information is information on which the editing process is performed by the editing section, and the second image object information is information in a format lower in load on the system than a format of the first image object information.

### BRIEF DESCRIPTION OF THE DRAWINGS

FIG. 1 is a diagram showing a display system according to an embodiment.

FIG. 2 is a block diagram showing a configuration of a display device.

FIG. 3 is a block diagram showing a configuration of an information processing device.

FIG. 4 is a diagram showing a translation of an image object.

FIG. 5 is a diagram showing expansion of the image object.

FIG. 6 is a diagram showing an example of a state in which a plurality of image objects is displayed.

FIG. 7 is a diagram showing an example of a time-dependent change of a load value.

FIG. 8 is a diagram showing an example of display of making an inquiry about whether or not switching from a first mode to a second mode can be made.

FIG. 9 is a flow chart showing a flow of the switching between the first mode and the second mode.

### DESCRIPTION OF AN EXEMPLARY EMBODIMENT

An embodiment of the present disclosure will hereinafter be described with reference to the accompanying drawings. It should be noted that in the drawings, the dimension of the scale size of each section is arbitrarily different from the reality, and some portions are schematically shown in order to make understanding easy. Further, the scope or the spirit of the present disclosure is not limited to the embodiment unless there is a particular description of limiting the present disclosure in the following explanation.

### 1. GENERAL DESCRIPTION OF DISPLAY SYSTEM

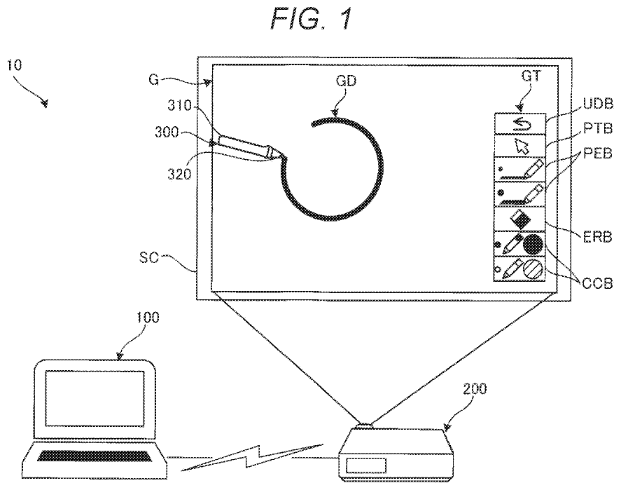

FIG. 1 is a schematic diagram showing a display system 10 according to the embodiment. The display system 10 is a projection system having an interactive function capable of displaying an image G including an image object GD corresponding to a drawing action with the pointing body 300. As shown in FIG. 1, the display system 10 includes a display device 200, the pointing body 300, and an information processing device 100.

The display device 200 is coupled to the information processing device 100 so as to be able to communicate with each other with wire or wirelessly. To the display device 200, there is input image information DS from the information processing device 100.

The display device 200 displays the image G based on the image information DS from the information processing device 100. It should be noted that the installation place of the screen SC is not particularly limited, but is, for example, a wall, a floor, or a table. Further, the installation place of the display device 200 is not particularly limited, but is, for example, a ceiling, the wall, the floor, a table, or a dedicated installation stage.

In the present embodiment, the display device 200 displays a toolbar GT which is an image for a GUI (Graphical User Interface) for making the display device 200 perform a variety of functions in accordance with pointing with the pointing body 300 so as to be superimposed on the image G. In the example shown in FIG. 1, the toolbar GT includes an undo button UDB, a pointer button PTB, pen buttons PEB, an eraser button ERB, and color selection buttons CCB. The undo button UDB is a button for undoing a previous operation. The pointer button PTB is a button for displaying a mouse pointer used for selecting an image and so on. The pen buttons PEB are buttons for selecting a type of a pen used for drawing the image object GD. The eraser button ERB is a button for selecting an eraser tool for erasing the image object GD which has already been drawn. The color selection buttons CCB are buttons for selecting a color of the pen used for drawing the image object GD.

It should be noted that although when using the toolbar GT having a configuration shown in FIG. 1 is hereinafter described as an example, the configuration of the toolbar GT is not limited to the example shown in FIG. 1. Further, an operation to the display device 200 can be made using an operation panel 241 provided to the main body of the display device 200 and a remote controller not shown in FIG. 1 besides when using the toolbar GT.

The image object GD included in the image G is a drawn image drawn by a trajectory of a position of the pointing body 300 due to a drawing action. It should be noted that the position of the pointing body 300 can be said to be a position of a predetermined region such as a tip of the pointing body 300, or can also be said to be a position on the screen SC pointed by the pointing body 300.

In the present embodiment, the display device 200 detects the position of the pointing body 300, and then transmits position information representing the detected position to the information processing device 100. The information processing device 100 generates image object information corresponding to the position information from the display device 200, and then generates the image information DS using the image object information. The image object information is first image object information D1 or second image object information D2 described later. It should be noted that hereinafter the first image object information D1 and the second image object information D2 are collectively referred to simply as “image object information.”

The pointing body 300 is a pen type device. The pointing body 300 is provided with a shaft part 310, and a tip button 320 disposed at the tip of the shaft part 310. The tip button 320 is a switch which is set to an ON state by being pressed against the screen SC. Inside the pointing body 300, there is disposed an infrared light emitting section not shown, and the infrared light emitting section is driven in response to the tip button 320 being set to the ON state. The infrared light emitting section is configured including a light emitting element such as an infrared LED (Light Emitting Diode), a light emission control circuit, and a power supply. The infrared light emitting section periodically emits infrared light using a method compliant with, for example, the IrDA (Infrared Data Association) standard. The light emission is detected by the display device 200. The display device 200 detects the position on the screen SC pointed by the pointing body 300 based on the light emission position of the pointing body 300. It should be noted that the shape of the pointing body 300 is not limited to the pen shape. Further, the pointing body 300 can also be a finger of a human.

The image G represented by the image information DS is an image obtained by superimposing the image object GD on an image such as a desktop image to be displayed on the information processing device 100. Therefore, for generation of the image information DS, there is used, for example, an image to be displayed on the information processing device 100 besides the image object information corresponding to the position information described above from the display device 200.

When generating the image information DS, the information processing device 100 changes the data format of the image object information in accordance with the situation of the load on the system in charge of the generation of the image object information described above. Specifically, as described later in detail, when the load value related to the load on the system is lower than a threshold value, the image processing device 100 generates the first object information D1 with the format on which an editing process can be performed. Therefore, it is possible to display the image object GD which can be edited. In contrast, when the load value related to the load on the system is equal to or higher than the threshold value, the information processing device 100 generates the second image object information D2 in a format which is lower in load on the system than that of the first image object information D1. Therefore, it is possible to reduce the generation of the time lag between the drawing action with the pointing body 300 and the display of the image object GD based on the drawing action.

### 2. CONFIGURATION OF DISPLAY DEVICE

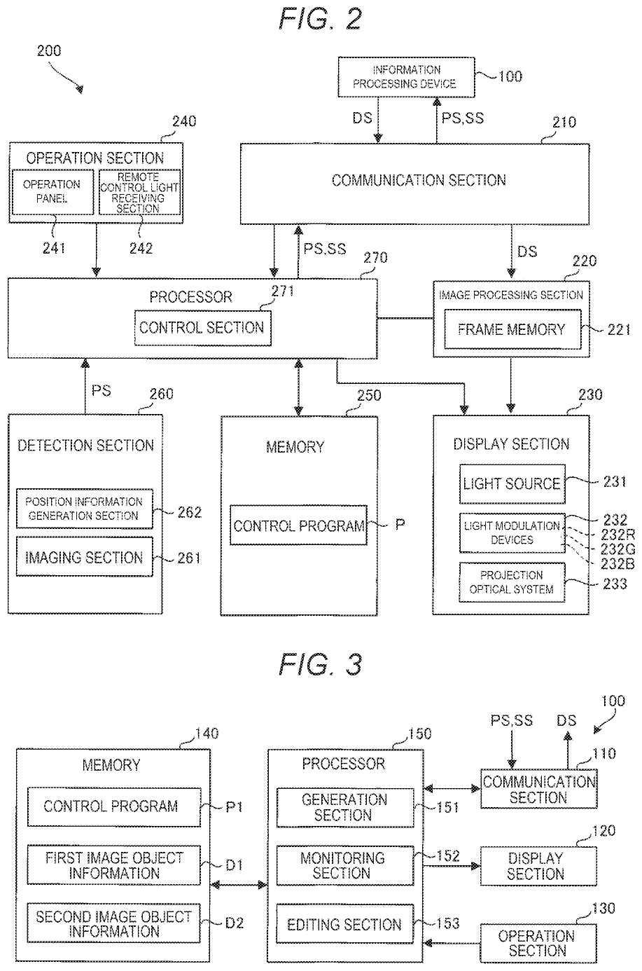

FIG. 2 is a block diagram showing a configuration of the display device 200 according to the embodiment. As shown in FIG. 2, the display device 200 has a communication section 210, an image processing section 220, a display section 230, an operation section 240, a memory 250, a detection section 260, and a processor 270. These are coupled to each other so as to be able to communicate with each other.

The communication section 210 is an interface coupled to the information processing device 100 so as to be able to communicate with each other. For example, the communication section 210 is an interface such as wireless or wired LAN (Local Area Network), a USB (Universal Serial Bus), or an HDMI (High Definition Multimedia Interface). USB and HDMI are each a registered trademark. It should be noted that the communication section 210 can be coupled to the information processing device 100 via another network such as the Internet. The communication section 210 is provided with an interface circuit for electrically processing a signal received via the wireless or wired interface.

The communication section 210 has a function of receiving a variety of types of information from the information processing device 100, and a function of transmitting a variety of types of information to the information processing device 100. Here, the communication section 210 receives a variety of types of information including the image information DS from the information processing device 100. Further, the communication section 210 transmits a variety of types of information including position information PS from the detection section 260 described later, and operation information SS from a control section 271 to the image processing device 100. It should be noted that although in FIG. 2 there is illustrated when the number of the information processing devices 100 to be coupled to the communication section 210 is one, the number of the information processing devices 100 to be coupled to the communication section 210 can be two or more.

The image processing section 220 is a circuit for generating an image signal for driving the display section 230 using the image information DS from the communication section 210. Specifically, the image processing section 220 has a frame memory 221, develops the image information DS in the frame memory 221 to arbitrarily execute a variety of processes such as a resolution conversion process, a resizing process, and a distortion correction process to thereby generate the image signal. Here, the image processing section 220 executes processing for making the display section 230 display the toolbar GT and so on as needed. The image signal generated by the image processing section 220 is input to the display section 230. The image processing section 220 is constituted by, for example, an integrated circuit. The integrated circuit includes an LSI, an ASIC (Application Specific Integrated Circuit), a PLD (Programmable Logic Device), an FPGA (Field-Programmable Gate Array), an SoC (System-on-a-Chip), and so on. Further, an analog circuit can also be included in a part of the configuration of the integrated circuit.

The display section 230 is a mechanism for displaying the image G based on the image signal from the image processing section 220. The display section 230 in the preset embodiment is a projection mechanism for displaying the image G by projecting the image G on the screen SC. Specifically, the display section 230 has a light source 231, a light modulation device 232, and a projection optical system 233.

The light source 231 includes, for example, a halogen lamp, a xenon lamp, a super-high pressure mercury lamp, an LED (Light Emitting Diode), or a laser source. The light source 231, for example, emits red light, green light, and blue light separately from each other, or emits white light. When the light source 231 emits the white light, the light emitted from the light source 231 is reduced in unevenness of the luminance distribution by an integrator optical system not shown, and is then separated by a color separation optical system not shown into the red light, the green light, and the blue light, and then enters the light modulation device 232.

The light modulation device 232 includes light modulation elements 232R, 232G, and 232B provided so as to correspond to the red light, the green light, and the blue light. The light modulation elements 232R, 232G, and 232B each include, for example, a transmissive liquid crystal panel, a reflective liquid crystal panel, or a DMD (Digital Mirror Device). The light modulation elements 232R, 232G, and 232B respectively modulate red light, green light, and blue light based on the image signal from the image processing section 220 to generate image light beams of the respective colors. The image light beams of the respective colors generated in the light modulation device 232 are combined by a color combining optical system to turn to full-color image light.

The projection optical system 233 images to project the full-color image light on the screen SC. The projection optical system 233 is an optical system including at least one projection lens, and can also include a zoom lens, a focus lens, or the like.

The operation section 240 is an input device for receiving the operation from the user. The operation section 240 has an operation panel 241 and a remote control light receiving section 242. The operation panel 241 is provided to an exterior chassis of the display device 200, and is configured to be able to receive an operation from the user. The operation panel 241 outputs a signal based on the operation from the user. The remote control light receiving section 242 receives an infrared signal from a remote controller not shown, and then decodes the infrared signal to output a signal based on the operation of the remote controller.

The memory 250 is a storage device for storing a control program P to be executed by the processor 270, and a variety of types of information to be processed by the processor 270. The memory 250 is constituted by, for example, a hard disk drive or a semiconductor memory. It should be noted that the memory 250 can be provided to a storage device, a server, or the like located outside the display device 200.

The detection section 260 detects a position of the pointing body 300 to generate the position information PS representing the position. The detection section 260 has an imaging section 261 and a position information generation section 262. The imaging section 261 takes an image of the screen SC. The imaging section 261 includes an imaging element such as a CCD (Charge Coupled Device) image sensor or a CMOS (Complementary MOS) image sensor. The position information generation section 262 generates the position information PS related to the position of the pointing body 300 based on an output signal of the imaging section 261. The position of the pointing body 300 is represented by, for example, a coordinate in a coordinate system set on the screen SC, and the position information PS includes information representing the coordinate. It should be noted that it is sufficient for the detection section 260 to be capable of detecting the position of the pointing body 300, and the pointing body 300 is not limited to the configuration using such an imaging element as described above, but can be, for example, a configuration using a laser source and a light receiving element.

The processor 270 is a processing device having a function of controlling each section of the display device 200 and a function of processing a variety of types of data. The processor 270 includes, for example, a CPU (Central Processing Unit). The processor 270 executes the control program P stored in the memory 250 to thereby function as the control section 271 for controlling each section of the display device 200. It should be noted that the processor 270 can be formed of a single processor, or can also be formed of a plurality of processors. Further, some or all of the functions of the processor 270 can also be realized by hardware such as a DSP (Digital Signal Processor), an ASIC (Application Specific Integrated Circuit), a PLD (Programmable Logic Device), or an FPGA (Field Programmable Gate Array).

The control section 271 controls each section of the display device 200, or processes the variety of types of data. Here, the control section 271 makes the display section 230 display the image G based on the image information DS. Further, in accordance with an operation to the toolbar GT described above, the control section 271 generates the operation information SS representing content of the operation.

### 3. CONFIGURATION OF INFORMATION PROCESSING DEVICE

FIG. 3 is a block diagram showing the configuration of the information processing device 100. The information processing device 100 is a computer which generates the image information DS based on the position information PS from the display device 200 to make the display device 200 display the image G based on the image information DS. It should be noted that the information processing device 100 is a notebook PC (Personal Computer) in the example shown in FIG. 1 described above, but is not limited thereto, and can be other types of portable information terminal such as a smartphone, a tablet terminal, or a portable video game player, or a stationary information terminal such as a desktop PC.

As shown in FIG. 3, the information processing device 100 has a communication section 110, a display section 120, an operation section 130, a memory 140, and a processor 150. These are coupled to each other so as to be able to communicate with each other.

The communication section 110 is an interface coupled to the communication section 210 of the display device 200 described above so as to be able to communicate with each other. For example, the communication section 110 is configured similarly to the communication section 210. The communication section 110 transmits a variety of types of information including the image information DS to the display device 200. Further, the communication section 110 receives a variety of types of information including the position information PS and the operation information SS from the display device 200.

The display section 120 displays a variety of images under the control by the processor 150. The display section 120 includes a variety of types of display panel such as a liquid crystal display panel, or an organic EL (electro-luminescence) display panel.

The operation section 130 is an input device for receiving the operation from the user. For example, the operation section 130 is configured including a pointing device including a touch pad, a touch panel, or a mouse. Here, when the operation section 130 is configured including a touch panel, the operation section 130 can also function as the display section 120.

The memory 140 is a storage device which stores a variety of programs such as a control program P1, an operation system, and an application program to be executed by the processor 150, and a variety of types of data such as the first image object information D1 and the second image object information D2 to be processed by the processor 150. The memory 140 is configured including, for example, a hard disk drive or a semiconductor memory. It should be noted that the memory 140 can be provided to a storage device, a server, or the like located outside the information processing device 100. Further, the memory 140 can include a frame memory used for the processing in a generation section 151 or an editing section 153.

The processor 150 is a processing device having a function of controlling each section of the information processing device 100 and a function of processing a variety of types of data. The processor 150 includes a processor such as a CPU (Central Processing Unit). The processor 150 executes the control program P1 stored in the memory 140 to thereby function as the generation section 151, a monitoring section 152, and the editing section 153.

It should be noted that the processor 150 can be formed of a single processor, or can also be formed of a plurality of processors. Further, some or all of the functions of the processor 150 can also be realized by hardware such as a DSP (Digital Signal Processor), an ASIC (Application Specific Integrated Circuit), a PLD (Programmable Logic Device), or an FPGA (Field Programmable Gate Array). Further, it is possible for the processor 150 to include an image processing circuit having a frame memory.

The generation section 151 generates the image information DS corresponding to the position of the pointing body 300. Specifically, the generation section 151 generates the first image object information D1 or the second image object information D2 corresponding to the position of the pointing body 300 based on the position information PS from the communication section 110, and then generates the image information DS using the first image object information D1 or the second image object information D2.

Here, the generation section 151 generates either one of the first image object information D1 and the second image object information D2 different in format from each other in accordance with the monitoring result of the monitoring section 152. Further, the generation section 151 stores the first image object information D1 or the second image object information D2 thus generated in the memory 140, and then generates the image information DS using the first image object information D1 or the second image object information D2 stored in the memory 140. Further, when the editing process is performed by the editing section 153 on the first image object information D1 or the second image object information D2 stored in the memory 140 as described later, the generation section 151 generates the image information DS using the first image object information D1 or the second image object information D2 on which the editing process has been performed. It should be noted that generation of the first image object information D1, the second image object information D2, and the image information DS will be described later in detail.

The monitoring section 152 monitors a load value related to the load on the system used for the generation section 151. The system is a computer system including the memory 140 and the processor 150. Therefore, the load on the system can be said to be a load on the image processing device 100. The higher the usage rate of the memory 140 or the processor 150 becomes, the higher the load on the system is. The larger the amount of the information handled by the system becomes, the higher the usage rate of the memory 140 or the processor 150 becomes. Here, the information handled by the system includes not only the first image object information D1 and the second image object information D2, but also a variety of types of information handled in the information processing device 100.

It should be noted that the computer system including the memory 140 and the processor 150 is hereinafter referred to simply as a “system.” Further, the load value related to the system is also referred to simply as a “load value.”

The monitoring section 152 in the present embodiment monitors the usage rate of the processor 150, the number of the image objects GD to be displayed, and the number of the pointing bodies 300 as monitoring objects. It should be noted that the monitoring objects of the monitoring section 152 are only required to be what changes in accordance with the load value of the system, and are not limited to the monitoring objects described above, and can be, for example, the usage rate of the memory 140.

The editing section 153 performs the editing process on the image information DS. Specifically, when an operation of selecting the pointer button PTB is performed on the toolbar GT, the editing section 153 performs the editing process on the image information DS in accordance with the position of the pointing body 300. On this occasion, the editing section 153 generates the image information DS representing the image G including the image object GD having been edited. Here, the editing section 153 identifies the position of the pointing body 300 based on the position information PS from the communication section 110. Further, the editing section 153 determines whether or not the operation of selecting the pointer button PTB has been performed on the toolbar GT based on the operation information SS from the communication section 110.

As the editing process in the editing section 153, there can be cited, for example, a translation process for translating the image object GD, a rotation process for rotating the image object GD, an expansion process for expanding the image object GD, a transformation process for transforming the image object GD, and an erasing process of erasing a part or the whole of the image object GD. Specific examples of the translation process and the expansion process out of these editing processes will hereinafter be described as representatives. It should be noted that the translation or the expansion of the image object GD described below is illustrative only, and the editing process is not limited thereto.

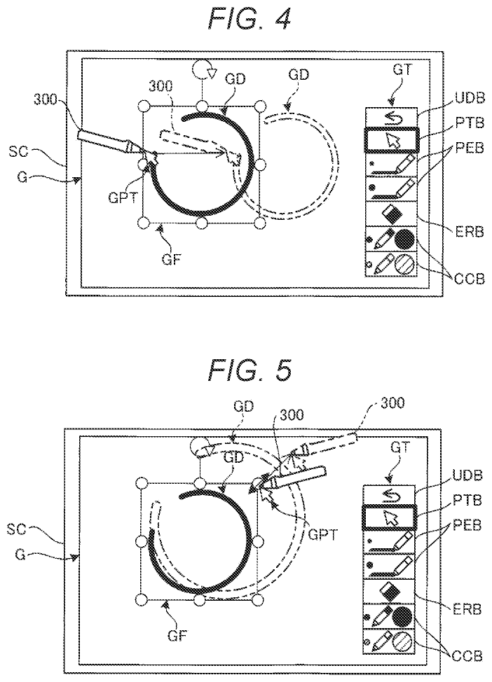

FIG. 4 is a diagram showing an example of the translation of the image object GD. FIG. 5 is a diagram showing an example of the expansion of the image object GD.

For example, as shown in FIG. 4 and FIG. 5, when the pointer button PTB is selected, the pointer GPT is displayed. In FIG. 4 and FIG. 5, the state in which the pointer button PTB is selected is shown using a thick line. The pointer GPT moves in the image G in accordance with the position of the pointing body 300.

For example, by the pointing body 300 being pressed against the screen SC at a position where the pointer GPT overlaps the image object GD, the image object GD is selected. Then, as shown in, for example, FIG. 4 and FIG. 5, there is displayed a frame GF representing the fact that the image object GD is selected.

In the example shown in FIG. 4 and FIG. 5, the frame GF forms a rectangular shape, there are disposed dots at the corners and midpoints of the respective sides of the frame GF. It should be noted that the configuration of the frame GF is not limited to the example shown in FIG. 4 and FIG. 5. Further, it is possible to show the selection of the image object GD using display different from the frame GF.

By pressing the pointing body 300 against the screen SC in the state in which the pointer GPT overlaps a part other than the dot on one of the sides of the frame GF, and then translating the pointing body 300 while being pressed against the screen SC, the image object GD moves as represented by the dashed-two dotted line in FIG. 4.

By pressing the pointing body 300 against the screen SC in the state in which the pointer GPT overlaps the dot on one of the corners of the frame GF, and then translating the pointing body 300 in a direction toward the outside of the frame GF while being pressed against the screen SC, the image object GD is expanded as represented by the dashed-two dotted line in FIG. 5.

It should be noted that by pressing the pointing body 300 against the screen SC in the state in which the pointer GPT overlaps the dot on one of the corners of the frame GF, and then translating the pointing body 300 in a direction toward the inside of the frame GF while being pressed against the screen SC, the image object GD is contracted. Further, by pressing the pointing body 300 against the screen SC in the state in which the pointer GPT overlaps the dot on one of the sides of the frame GF, and then translating the pointing body 300 in a direction crossing the side of the frame GF while being pressed against the screen SC, aspect ratio of the image object GD changes.

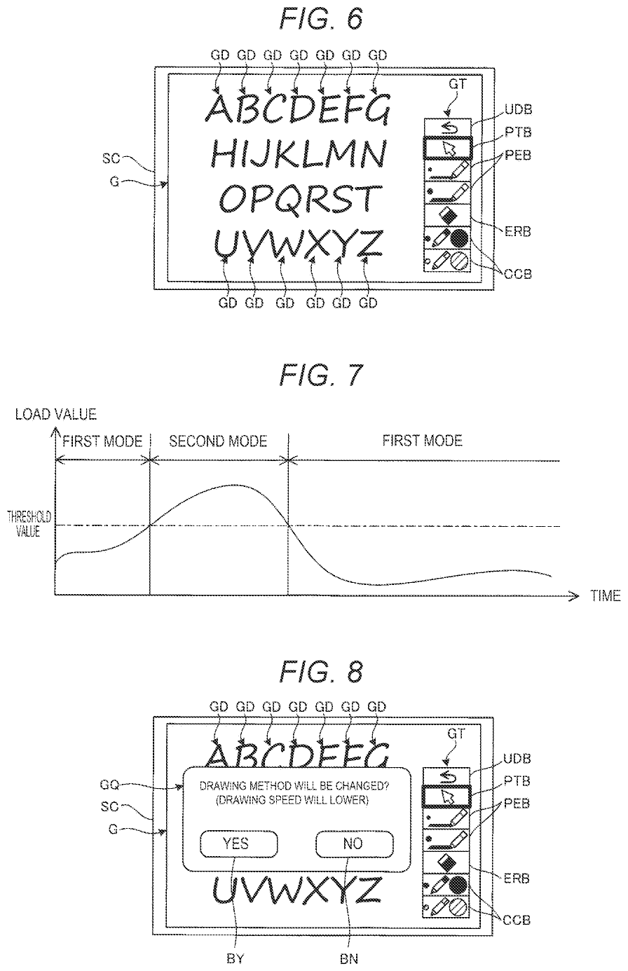

FIG. 6 is a diagram showing an example of a state in which a plurality of image objects GD is displayed. In FIG. 6, there is illustrated when each of the image objects GD represents an alphabetical letter. The larger the number of the image objects GD to be displayed becomes, the more the load on the system increases. When the load on the system becomes too high, the processing speed in the generation section 151 decreases. The decrease in the processing speed in the generation section 151 is one of the factors which incurs an increase in time lag between the drawing action with the pointing body 300 and the display of the image object GD based on the drawing action.

Therefore, the generation section 151 changes the data format of the image object information in accordance with whether or not the load value monitored by the monitoring section 152 described above is no lower than a threshold value. Here, when at least one of the monitoring objects of the monitoring section 152 described above exceeds a preset value, the generation section 151 determines that the load value is no lower than the threshold value.

The preset value is determined in accordance with the type of the monitoring object, or a processing capacity of the system. The preset value related to the usage rate of the processor 150 is decided in accordance with the processing capacity of the system, and is preferably, for example, no lower than 70% and no higher than 100%, and is more preferably no lower than 80% and no higher than 90% although not particularly limited. The preset value related to the number of image objects GD is decided in accordance with the processing capacity of the system, and is preferably, for example, no smaller than 10 and no larger than 100, and is more preferably no smaller than 30 and no larger than 50 although not particularly limited. The preset value related to the number of the pointing bodies 300 is decided in accordance with the processing capacity of the system, and is preferably, for example, no smaller than 2 and no larger than 5, and is more preferably 2 or 3 although not particularly limited.

FIG. 7 is a diagram showing an example of a time-dependent change of the load value. As shown in FIG. 7, when the load value is lower than the threshold value, the generation section 151 performs a first mode, and in contrast, when the load value is no lower than the threshold value, the generation section 151 performs a second mode.

In the first mode, the generation section 151 generates the first image object information D1 in accordance with the position of the pointing body 300, and then generates the image information DS using the first image object information D1.

The first image object information D1 is information on which the editing section 153 can perform the editing process. The first image object information D1 generated by the generation section 151 is stored in the memory 140, and is then used for the editing process in the editing section 153 as needed.

The first image object information D1 is only required to have a format on which the editing section 153 can perform the editing process, and is preferably information having a vector format. The vector format is a format of expressing an image as an aggregate of analytic geometric diagrams such as circles or straight lines. Therefore, in the image object GD based on the information in the vector format, it is easy to perform the editing such as expansion, contraction, or transformation, and at the same time, deterioration in image quality due to the editing does not occur. Therefore, since the first image object information D1 is the information in the vector format, it is possible to edit the image object GD based on the first image object information D1 in good condition.

Further, it is preferable for the information in the vector format used for the first image object information D1 to be information which represents the first image object information D1 object by object. In this case, it is possible to edit the image object GD object by object. Here, “object by object” means that an element such as a straight line, a curved line, a character, of a diagram are defined as a processing unit.

In contrast, in the second mode, the generation section 151 generates the second image object information D2 in accordance with the position of the pointing body 300, and then generates the image information DS using the second image object information D2.

The second image object information D2 is information in a format lower in load on the system than that of the first image object information D1. The second image object information D2 generated by the generation section 151 is stored in the memory 140, and is then used for the editing process in the editing section 153 as needed.

The second image object information D2 is only required to be in the format lower in load on the system than that of the first image object information D1, but is preferably information in a raster format. The raster format is a format which expresses an image as an aggregate of pixels having color information and so on. In general, the load on the processing of generating the information in the raster format is lower than the load on the processing of generating the information in the vector format. Therefore, since the second image object information D2 is the information in the raster format, it is possible to reduce occurrence of the time lag between the drawing action by the pointing body 300 when performing the second mode and the display of the image object GD based on the drawing action in good condition. Further, since the raster format is substantially the same as the display format in the display device 200, such a rasterizing process as when using the vector format is unnecessary when generating the image information DS. Therefore, also from this point of view, it is possible to reduce the generation of the time lag between the drawing action with the pointing body 300 and the display of the image object GD based on the drawing action when performing the second mode in good condition.

FIG. 8 is a diagram showing an example of display of making an inquiry about whether or not switching from the first mode to the second mode can be made. When the load value monitored by the monitoring section 152 has changed from a value lower than the threshold value to a value equal to or higher than the threshold value, the generation section 151 makes the display section 230 display an inquiry image GQ for making the inquiry about whether or not the switching from the first mode to the second mode can be made as shown in FIG. 8. In the example shown in FIG. 8, in the inquiry image GQ, there are displayed character strings of “DRAWING METHOD WILL BE CHANGED?” AND “DRAWING SPEED WILL LOWER,” and buttons BY and BN for accepting the operation by the pointing body 300. It should be noted that the display content of the inquiry image GQ is only required to be a content which inquires about whether or not the switching from the first mode to the second mode can be made, but is not limited to the example shown in FIG. 8, and is therefore arbitrary.

The button BY is a button for allowing the generation section 151 to switch from the first mode to the second mode. When the button BY is operated, the generation section 151 switches from the first mode to the second mode. The button BN is a button for denying the switching from the first mode to the second mode. When the button BN is operated, the generation section 151 keeps the first mode without switching from the first mode to the second mode. It should be noted that it is possible to perform the operation of determining whether to allow the generation section 151 to switch from the first mode to the second mode can be performed by other devices than the inquiry image GQ such as the operation section 130.

When the switching from the first mode to the second mode is performed, the first image object information D1 having already been generated can be kept stored in the memory 140, or can be deleted from the memory 140. When the first image object information D1 is kept stored in the memory 140, it is possible to edit the image object GD based on the first image object information D1 stored in the memory 140 even after being switched from the first mode to the second mode. In contrast, when the first image object information D1 is to be deleted from the memory 140, it is possible to reduce the load on the system compared to when the first image object information D1 is kept stored in the memory 140, and as a result, it is possible to increase the generation speed of the image information DS in the generation section 151.

When deleting the first image object information D1 from the memory 140, it is possible to rasterize the first image object information D1 from the vector format to the raster format, and then store the object information having been rasterized in the memory. It should be noted that the rasterizing process incurs an increase in load on the system, and therefore preferably performed in a period when the drawing action is not performed.

### 4. OPERATION OF DISPLAY SYSTEM

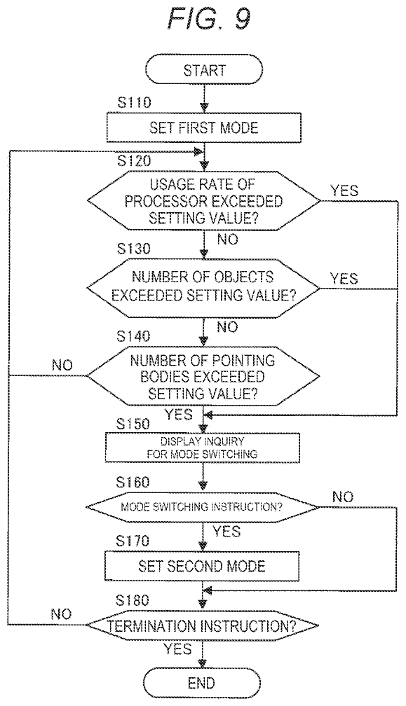

FIG. 9 is a flow chart showing a flow of the switching between the first mode and the second mode. In the information processing device 100, first, as shown in FIG. 9, the generation section 151 sets the first mode in the step S110. On this occasion, the monitoring section 152 monitors the load value related to the load on the system.

Then, in the step S120, the generation section 151 judges whether or not the usage rate of the processor 150 has exceeded the preset value.

When the usage rate of the processor 150 does not exceed the preset value, the generation section 151 judges in the step S130 whether or not the number of the image objects GD to be displayed exceeds the preset value.

When the number of the image objects GD to be displayed does not exceed the preset value, the generation section 151 judges in the step S140 whether or not the number of the pointing bodies 300 in the active state exceeds the preset value. For example, by the control section 271 making the communication section 210 transmit the information related to the number of the pointing bodies 300 detected by the detection section 260 to the communication section 110, then the communication section 110 transmitting the information related to the number of the pointing bodies 300 detected by the detection section 260 to the processor 150, then the monitoring section 152 of the processor 150 monitoring the information related to the number of the pointing bodies 300, and then the monitoring section 152 notifying the generation section 151 when the monitoring section 152 has judged that the number of the pointing bodies 300 has exceeded the preset value, the generation section 151 judges that the number of the pointing bodies 300 in the active state has exceeded the preset value.

When the usage rate of the processor 150 does not exceed the preset value, the number of the image objects GD to be displayed does not exceed the preset value, and at the same time, the number of the pointing bodies 300 in the active state does not exceed the preset value, the generation section 151 returns to the step S120 described above.

In contrast, when the usage rate of the processor 150 has exceeded the preset value, the number of the image objects GD to be displayed has exceeded the preset value, or the number of the pointing bodies 300 in the active state has exceeded the preset value, the generation section 151 makes the display section 230 display the inquiry image GQ in the step S150.

After displaying the inquiry image GQ, the generation section 151 judges in the step S160 whether or not there exists an instruction of the switching from the first mode to the second mode. Here, when an operation is performed on the button BY of the inquiry image GQ, the generation section 151 judges that the instruction of the switching from the first mode to the second mode is made, and in contrast, when an operation is performed on the button BN of the inquiry image GQ, the generation section 151 judges that the instruction of the switching from the first mode to the second mode is not made.

When the instruction of the switching from the first mode to the second mode is made, the generation section 151 switches from the first mode to the second mode in the step S170, and then makes the transition to the step S180. In contrast, when the instruction of the switching from the first mode to the second mode is not made, the generation section 151 makes the transition to the step S180 without switching from the first mode to the second mode.

In the step S180, the generation section 151 judges whether or not a termination instruction is made, and terminates the process when the termination instruction is made, or returns to the step S120 described above when the termination instruction is not made.

As described hereinabove, the method of controlling the display device 200 displays the image G based on the image information DS generated in accordance with the position of the pointing body 300. This control method is performed in the display system 10. The display system 10 has the display device 200 and the information processing device 100. The information processing device 100 makes the display device 100 display the image G based on the image information DS generated in accordance with the position of the pointing body 300.

The display device 200 has the display section 230 for displaying the image G based on the image information DS. The information processing device 100 has the generation section 151, the monitoring section 152, and the editing section 153. The generation section 151 generates the image information DS in accordance with the position of the pointing body 300. The monitoring section 152 monitors the load value related to the load on the system used for the generation section 151. The editing section 153 performs the editing process on the image information DS.

Here, the generation section 151 performs the first mode when the load value is lower than the threshold value, or performs the second mode when the load value is no lower than the threshold value. In the first mode, the generation section 151 generates the first image object information D1 in accordance with the position of the pointing body 300, and then generates the image information DS using the first image object information D1. The first image object information D1 is information on which the editing section 153 can perform the editing process. In contrast, in the second mode, the generation section 151 generates the second image object information D2 in accordance with the position of the pointing body 300, and then generates the image information DS using the second image object information D2. The second image object information D2 is the information in the format lower in load on the system than that of the first image object information D1.

In the method of controlling the display device 200, the information processing device 100, and the display system 10 described hereinabove, the first image object information D1 on which the editing process can be performed is generated in the first mode. Therefore, it is possible to edit the image object GD based on the first image object information D1.

In contrast, in the second mode, the second image object information D2 in the format lower in processing load than that of the first image object information D1 is generated. Therefore, since the processing load on the system is reduced compared to when performing the first mode, it is possible to increase the generation speed of the image information DS. As a result, in the second mode, it is possible to reduce the occurrence of the time lag between the drawing action with the pointing body 300 and the display of the image object GD based on the drawing action compared to when performing the first mode.

Here, since the first mode and the second mode are switched based on whether or not the load value is no lower than the threshold value, the advantages in the first mode and the second mode described above can be obtained without unnecessarily limiting the editing of the image object GD.

It is preferable for the first image object information D1 to be the information in the vector format. In this case, it is possible to edit the image object GD based on the first image object information D1 in good condition. In contrast, it is preferable for the second image object information D2 to be the information in the raster format. In this case, it is possible to reduce the generation of the time lag between the drawing action with the pointing body 300 and the display of the image object GD based on the drawing action when performing the second mode in good condition.

It is preferable for the information in the vector format used for the first image object information D1 to be the information which represents the first image object information D1 object by object. In this case, it is possible to edit the image object GD object by object.

When the usage rate of the processor 150 included in the system is no lower than the preset value, the generation section 151 judges that the load value is no lower than the threshold value. The higher the usage rate of the processor 150 is, the higher the load value related to the load on the system is. Therefore, when the usage rate of the processor 150 is no lower than the preset value, it is possible to judge that the load value is no lower than the threshold value.

Further, when the number of the image objects GD based on the first image object information D1 is no lower than the preset value, the generation section 151 judges that the load value is no lower than the threshold value. The larger the number of the image objects GD is, the higher the load value related to the load on the system is. Therefore, when the number of the image objects GD is no lower than the preset value, it is possible to judge that the load value is no lower than the threshold value.

Therefore, when the number of the pointing bodies 300 is no lower than the preset value, the generation section 151 judges that the load value is no lower than the threshold value. The larger the number of the pointing bodies 300 is, the higher the load value related to the load on the system is. Therefore, when the number of the pointing bodies 300 is no lower than the preset value, it is possible to judge that the load value is no lower than the threshold value.

Further, when the load value is no lower than the threshold value, the generation section 151 makes the display device 200 display the inquiry image GQ for making the inquiry about whether to switch from the first mode to the second mode. Therefore, even when the load value is no lower than the threshold value, it is possible to prevent the switching from the first mode to the second mode despite the intention of the user.

Further, when performing the second mode, it is preferable for the generation section 151 to limit the editing on the image information DS. In this case, it is possible to reduce the load on the system compared to when performing editing in the second mode.

### 5. MODIFIED EXAMPLES

Each of the configurations illustrated hereinabove can variously be modified. Some specific configurations of the modifications which can be applied to each of the configurations described above will be illustrated below. Two or more aspects arbitrarily selected from the following illustrations can arbitrarily be combined with each other unless conflicting with each other.

Although in the configuration described above, there is illustrated when all of the generation section 151, the monitoring section 152, and the editing section 153 are the constituents of the information processing device 100, this illustration is not a limitation, and it is also possible to adopt some or all of the generation section 151, the monitoring section 152, and the editing section 153 as the constituents of the display device 200. Further, it is possible to adopt a part of the generation section 151, a part of the monitoring section 152, or a part of the editing section 153 as the constituents of the display device 200.

Further, although there is illustrated when the display device 200 is a projector in the configuration described above, the display device according to the present disclosure is not limited to the projector, and can also be a display device such as a liquid crystal display, a plasma display, or an organic EL (electro-luminescence) display.

Further, although in the configuration described above, there is illustrated the configuration in which the display device 200 and the information processing device 100 are separated from each other, this configuration is not a limitation, and it is possible to integrate the display device 200 and the information processing device 100 with each other. Specifically, all of the generation section 151, the monitoring section 152, the editing section 153, and the display section 230 can be adopted as the constituents of the information processing device such as a PC, or can also be adopted as the constituents of the display device such as a projector, a liquid crystal display, a plasma display, or an organic EL (electro-luminescence) display.

Further, although in the configuration described above, there is illustrated when the monitoring objects of the monitoring section 152 are the usage rate of the processor 150, the number of the image objects GD, and the number of the pointing bodies 300, the illustration is not a limitation, and it is sufficient for the monitoring objects of the monitoring section 152 to include at least one of the monitoring objects described above.

Further, although in the configuration described above, there is illustrated the embodiment in which the inquiry image GQ is displayed when the load value monitored by the monitoring section 152 changes from a value lower than the threshold value to a value no lower than the threshold value, this configuration is not a limitation. For example, when the load value monitored by the monitoring section 152 changes from the value lower than the threshold value to the value no lower than the threshold value, it is possible to switch from the first mode to the second mode without displaying the inquiry image GQ.

Further, although in the configuration described above, there is illustrated the configuration in which the display device 200 displays the toolbar GT so as to be superimposed on the image G, and the control section 271 generates the operation information SS representing the operation content in accordance with the operation to the toolbar GT, this configuration is not a limitation. For example, it is possible to include information of displaying substantially the same image as the toolbar GT in the image information DS, and include the toolbar GT in the image G. Further, in this case, it is possible for the processor 150 to receive the position information PS via the communication section 110, and then generate the operation information SS based on the position information PS.

What is claimed is:

1. A method of controlling a display device configured to display an image based on image information generated in accordance with a position of a pointing body, the method comprising:
monitoring a load value related to a load on a system which is configured to generate the image information in accordance with the position of the pointing body;
performing a first mode configured to generate first image object information on which an editing process is performed, in accordance with the position of the pointing body, and then generate the image information using the first image object information when the load value is lower than a threshold value; and
performing a second mode configured to generate second image object information in a format lower in the load on the system than a format of the first image object information in accordance with the position of the pointing body, and then generate the image information using the second image object information when the load value is equal to or higher than the threshold value.

2. The method of controlling the display device according to claim 1, wherein
the first image object information is information in a vector format, and
the second image object information is information in a raster format.

3. The method of controlling the display device according to claim 2, wherein
the information in the vector format is information representing the first image object information object by object.

4. The method of controlling the display device according to claim 1, wherein
the system includes a processor, and
when a usage rate of the processor is equal to or higher than a preset value, it is judged that the load value is equal to or higher than the threshold value.

5. The method of controlling the display device according to claim 1, wherein
when a number of image objects based on the first image object information is equal to or larger than a preset value, it is judged that the load value is equal to or higher than the threshold value.

6. The method of controlling the display device according to claim 1, wherein
when a number of the pointing bodies is equal to or larger than a preset value, it is judged that the load value is equal to or higher than the threshold value.

7. The method of controlling the display device according to claim 1, wherein
when the load value is equal to or higher than the threshold value, the display device is made to display an inquiry image configured to make an inquiry about whether to switch from the first mode to the second mode.

8. The method of controlling the display device according to claim 1, wherein
when performing the second mode, editing on the image information is limited.

9. An information processing device configured to make a display device display an image based on image information generated in accordance with a position of a pointing body, the information processing device comprising:
a generation section configured to generate the image information in accordance with the position of the pointing body;
a monitoring section configured to monitor a load value related to a load on a system used for the generation section; and
an editing section configured to perform an editing process on the image information, wherein
the generation section performs
a first mode configured to generate first image object information in accordance with the position of the pointing body, and then generate the image information using the first image object information when the load value is lower than a threshold value, and
a second mode configured to generate second image object information in accordance with the position of the pointing body, and then generate the image information using the second image object information when the load value is equal to or higher than the threshold value,
the first image object information is information on which the editing process is performed by the editing section, and
the second image object information is information in a format lower in load on the system than a format of the first image object information.

10. A display system comprising:
a generation section configured to generate image information in accordance with a position of a pointing body;
a monitoring section configured to monitor a load value related to a load on a system used for the generation section;
an editing section configured to perform an editing process on the image information; and
a display section configured to display an image based on the image information, wherein
the generation section performs
a first mode configured to generate first image object information in accordance with the position of the pointing body, and then generate the image information using the first image object information when the load value is lower than a threshold value, and
a second mode configured to generate second image object information in accordance with the position of the pointing body, and then generate the image information using the second image object information when the load value is equal to or higher than the threshold value,
the first image object information is information on which the editing process is performed by the editing section, and
the second image object information is information in a format lower in load on the system than a format of the first image object information.
